(19) United States
(12) Patent Application Publication
(10) Pub. No.: US 2018/0363096 A1
(43) Pub. Date: Dec. 20, 2018

(54) METHOD FOR FORMING VARIED STRENGTH ZONES OF A VEHICLE COMPONENT

(71) Applicant: Ford Global Technologies, LLC, Dearborn, MI (US)

(72) Inventors: Raj Sohmshetty, Canton, MI (US); Constantin Chiriac, Windsor (CA)

(21) Appl. No.: 15/625,286

(22) Filed: Jun. 16, 2017

(51) Int. Cl. C21D 11/00; C21D 1/673

(52) U.S. Cl. CPC C21D 11/00; C21D 1/673; B60R 19/03; C21D 2221/01; C21D 2211/008

(57) ABSTRACT

A vehicle component strength zone forming method is provided. The method includes identifying a condition of a blank via sensors at a furnace inlet. The method further includes outputting, by a controller, furnace command signals based on a predetermined thermal treatment schedule for the identified condition of the blank to heat a first blank portion to form a fully martensitic microstructure and heat a second blank portion to form a microstructure having one or more of ferrite, pearlite, and austenite. The method may further include outputting the furnace command signals based on furnace temperature variations detected by furnace sensors in communication with the controller. The method may further include outputting the furnace command signals based on one or more of a detected blank chemical composition, a detected type of blank coating, a detected blank thickness, and a detected blank material type.

### TECHNICAL FIELD

This disclosure relates to a method and process for forming varied strength zones of a vehicle component.

### BACKGROUND

Automotive manufacturers are driven to design light weight vehicles with increased crash performance and reduced fuel consumption. The manufacturers have transitioned from a usage of mild steels for vehicle components to advanced high strength steels and ultra-high strength steels along with aluminum. Hot stamping processes for vehicle components allow creation of fully martensitic structures. However, uniform thermal treatment of vehicle components during the hot stamping process may create vehicle components with undesirable qualities.

For example, hot stamping processes may result in vehicle components having joining issues with steel alloys and aluminum and in vehicle components requiring a high strength cutter for blanking operations. This disclosure is related to solving the above problems and other problems summarized below.

### SUMMARY

A method for forming varied strength zones of a vehicle component includes selecting a material for a blank and identifying a thermal treatment schedule for at least three blank zones based on a selected design requirement specifying a blank location for one of a geometry transition region, a predetermined deformation region, and a joining region. The method further includes arranging the blank within a furnace so that predetermined heat zones align with the blank zones to form predetermined microstructures based on the design requirement. The method further includes executing the thermal treatment schedule to form the predetermined microstructures of the blank zones and forming the blank into the vehicle component in a die. [0015] The selection of a material for the blank may include selecting a press hardenable steel grade from one of 20MNB5, 22MNB5, 8MNCrB3, 27MnCrB5, 37MnB4, Aperam Hot Forming Grades, Ductibor, HF 340/480, Usibor 1500, HF1050/1500, Usibor 1900, HF 1200/1900, and US Steel 10B20. The method may further include detecting whether the blank includes a coating prior to execution of the thermal treatment schedule. A first thermal treatment schedule may be applied to the blank when a coating is detected and a second thermal treatment schedule may be applied to the blank when a coating is not detected. The first thermal treatment schedule may further be defined as a thermal treatment schedule in which furnace heat output is based on material characteristics of one of zinc, aluminum-silicon, and zinc nickel and predetermined temperatures necessary to form a blank microstructure including one of soft strength zone characteristics, medium strength zone characteristics, and hard strength zone characteristics. The method may further include arranging the blank within the furnace so that one of the at least three blank zones extends outside of the furnace to receive minimal or no heat. A temperature of one of the predetermined heat zones may be 900 degrees Celsius or greater than an Ac3 temperature of the material to form a hard strength zone. A temperature of one of the predetermined heat zones may be between Ac1 and Ac3 temperatures of the selected material of the blank to form a medium strength zone of the blank located adjacent a hard strength zone of the blank. The medium strength zone may be defined in the selected design requirement to achieve strength levels in between a blank as received condition and a fully hardened condition of a press hardenable steel material.

A vehicle component strength zone forming method includes identifying a condition of a blank via sensors at a furnace inlet. The method further includes outputting, by a controller, furnace command signals based on a predetermined thermal treatment schedule for the identified condition of the blank to heat a first blank portion to form a fully martensitic microstructure and heat a second blank portion to form a microstructure having one or more of ferrite, pearlite, and austenite. The method may further include outputting the furnace command signals based on furnace temperature variations detected by furnace sensors in communication with the controller. The method may further include outputting the furnace command signals based on one or more of a detected blank chemical composition, a detected type of blank coating, a detected blank thickness, and a detected blank material type. The furnace command signals may be based on detection of the blank being one of Aperam Hot Forming Grades, Ductibor, HF 340/480, Usibor 1500, HF1050/1500, Usibor 1900, HF 1200/1900, and US Steel 10B20. The method may further include detecting whether the blank includes a coating prior to execution of the thermal treatment schedule. A first thermal treatment schedule may be applied to the blank when a coating is detected and a second thermal treatment schedule may be applied to the blank when a coating is not detected. The first thermal treatment schedule may further be defined as a thermal treatment schedule in which furnace heat output is based on material characteristics of one of zinc, aluminum-silicon, and zinc nickel and predetermined temperatures necessary to form a blank microstructure including one of soft strength zone characteristics, medium strength zone characteristics, and hard strength zone characteristics. The method may further include selecting a location for the first blank portion on a vehicle component based on a predetermined design requirement having one of a geometry transition region, a predetermined deformation region, and a joining region.

A method for forming varied strength zones of a vehicle component includes selecting a type of material for a blank to form into a vehicle component based on a predetermined strength requirement and a corrosion protection requirement for the vehicle component. The method further includes selecting a thermal treatment schedule based on the type of material and executing the thermal treatment schedule within a furnace to treat the blank to form varied strength zones along the vehicle component. The method further includes executing a tailored cooling process for separate portions of the blank to form at least two different strength zone microstructures adj acent one another at one of a geometry transition region, a predetermined deformation region, and a joining region. The selection of the thermal treatment schedule may be from one of a first schedule in which the blank is fully inserted into a furnace and a second schedule in which a portion of the blank extends outside the furnace. The furnace may include more than one heat zone for heating at different temperatures. The blank may be positioned in the furnace so that blank zones align with the more than one heat zones to form microstructures for the blank zones based on predetermined design requirements. A temperature of one of the heat zones may be between Ac1 and Ac3 at approximately 700 to 900 degrees Celsius to form a medium strength zone of the blank located adjacent a hard strength zone of the blank. The medium strength zone may be arranged to deform and absorb a portion of energy received from an axial load to the vehicle component of between 5,000 and 15,000 pounds. The method may further include detecting, via sensors, furnace thermal conditions and outputting a furnace command, via a controller, to adjust a temperature of the furnace based on the detected thermal condition.

### BRIEF DESCRIPTION OF THE DRAWINGS

FIG. 1 is a flow chart showing an example of a method for forming multiple strength zones of a vehicle component.

FIG. 2 is a schematic diagram, in cross-section, of an example of a heating apparatus and a blank arranged with one another for targeted thermal treatment.

FIG. 3 is a side view of an example of a front rail of an underbody assembly.

FIG. 4 is a perspective view of an example of a bumper beam assembly.

FIG. 5 is a side view of an example of a rear rail of an underbody assembly.

FIG. 6 is a perspective view of a fuel tank protection assembly.

FIG. 7 is a diagrammatic view showing an example of a hot stamping process.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present disclosure. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be used in particular applications or implementations.

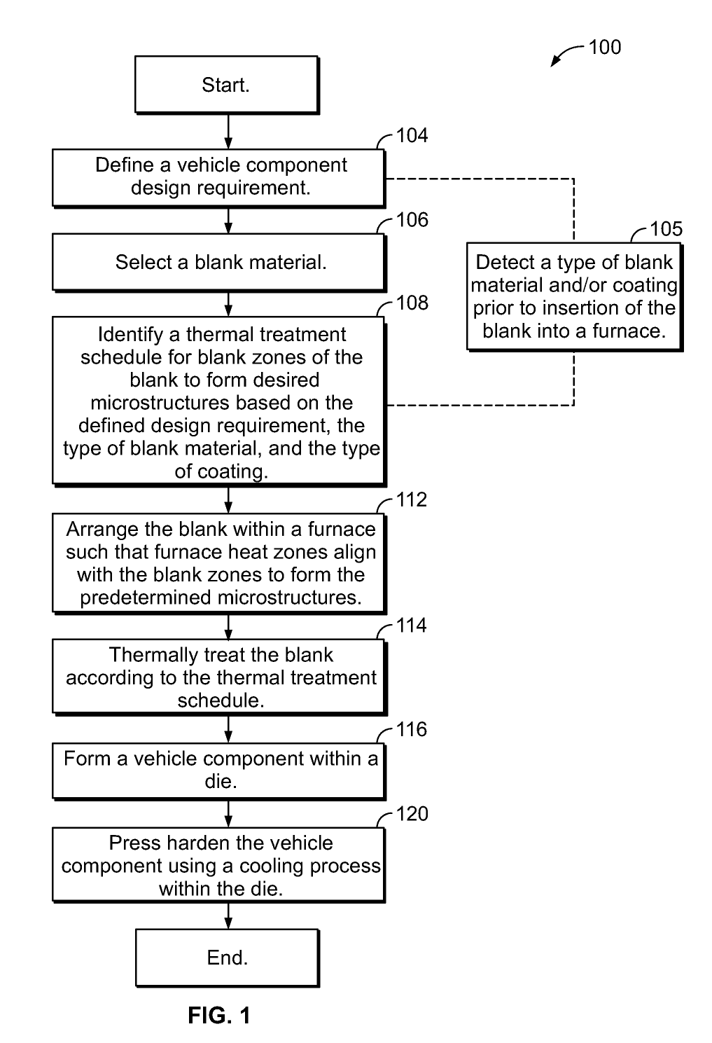

FIG. 1 is a flow chart showing an example of a method to form a vehicle component having varied strength zones, referred to as a method 100. In operation 104, a vehicle component design requirement is identified. For example, a type of a vehicle component may be identified along with structural rigidity requirements in operation 104. Non-limiting examples of the type of vehicle component include an underbody assembly rear rail, an underbody assembly front rail, a bumper beam, and cross members of a fuel tank protection assembly. In another example, the design requirement may be a strength requirement or a corrosion protection requirement for a vehicle component.

The structural rigidity requirements may include deformation characteristics for the vehicle component when subjected to an impact. These deformation characteristics may be based on impact performance due to microstructures of various portions of the vehicle component which correspond to a strength zone. For example, a harder strength zone may be desired in a zone of the vehicle component with a geometry transition such as a bend. A softer strength zone may be desired in a zone of the vehicle component where deformation under impact is desired. This deformation may assist in absorbing energy from the impact and may create a living hinge at a targeted location. Alternatively, a softer strength zone may be desired in a zone of the vehicle component to facilitate joining or securing to another vehicle component. Additional examples of design requirements include material formability characteristics, material paintability characteristics, material corrosion characteristics, and vehicle component joining requirements.

Optionally, the method 100 may operate with an adaptive system to adjust thermal treatment of the blank based on detected blank or vehicle component conditions. For example, in operation 105 one or more sensors may operate with a furnace and a controller to assist in identifying information relating to a type of blank material and a condition of the blank. The sensors may provide the information to the controller and the controller may output furnace control commands based on predetermined thermal treatment schedules associated with the information. In one example, the one or more sensors may detect a blank having a first thickness and a type of coating. The controller may output commands to control an amount of heat output and a time of heat output by the furnace to various furnace heat zones based on a predetermined thermal treatment schedules according to the first thickness and the type of coating.

The one or more sensors may include furnace sensors. The furnace sensors may monitor thermal operating conditions of the furnace and provide the monitored information to the controller so the controller may adjust thermal output of the furnace in response thereto. For example, the furnace sensors may detect a temperature within the furnace less than an initial temperature command. In this example, the controller may adjust the temperature of the furnace to compensate for the difference between the measured furnace temperature and an initial temperature command.

In operation 106, a type of a blank material is selected. Different types of blank materials have different characteristics which may or may not be desirable for particular thermal treatment applications. Examples of materials for blanks include Aperam Hot Forming Grades, Ductibor (HF 340/480), Usibor 1500 (HF1050/1500), Usibor 1900 (HF 1200/1900), US Steel 10B20, Boron, 20MNB5, 22MNB5, 8MNCrB3, 27MnCrB5, and 37MnB4.

The selected blank material may be coated or uncoated. Determination of whether the blank includes a coating and a type of coating may be detected in operation 105. The coating may assist in minimizing or preventing oxidation of a surface of the blank under certain thermal conditions such as a heat treatment of 250 degrees Celsius or higher. The coating may also provide corrosion resistance benefits for vehicle components which may be later subjected to environment conditions. Examples of substances for the coating include zinc, aluminum-silicon, and zinc-nickel. Uncoated blanks may be used to reduce production costs or for vehicle components that do not need to be designed for surface corrosion prevention.

In operation 108, a thermal treatment schedule is identified to thermally treat targeted zones of the blank based on the previously defined design requirement and blank material selection to form predetermined microstructures of the vehicle component. The thermal treatment schedule may include a heating process in which the blank is fully inserted into a furnace or a thermal treatment schedule in which a portion of the blank extends out of the furnace.

For example, the portion of the blank extending out of the furnace may receive minimal or no heat to retain soft strength zone characteristics. A soft strength zone may be thermally treated for sub-critical annealing or no heating. The soft strength zone may include a microstructure having one or both of ferrite and pearlite. The soft strength zone may have a tensile strength of 400 MPa to 600 MPa. The other portions of the blank fully inserted into the furnace may be heat treated to form a medium strength zone or a hard strength zone. A medium strength zone may be thermally treated between Ac1 and Ac3 for inter-critical annealing. The medium strength zone may include a microstructure having one or more of ferrite, pearlite, martensite, and bainite. The medium strength zone may have a tensile strength of 600 MPa to 1000 MPa. A hard strength zone may be thermally treated above Ac3 for super-critical annealing. The hard strength zone may include a fully martensitic microstructure. The hard strength zone may have a tensile strength of 1000 MPa to 1900 MPa.

If a coated material is selected for the blank, the thermal treatment schedule to form a soft strength zone may include heating the blank below Acl utilizing convection heating at a temperature to develop the coating to prevent issues with downstream processes such as formability. Ac1 is a temperature at which a material begins to form austenite. A temperature associated with Ac1 will vary depending on the type of material and whether the material is coated or uncoated. Alternatively, portions of the blank where a soft strength zone is desired may be arranged to receive minimal or no heat to retain a microstructure of the blank as delivered.

With a coated blank, the thermal treatment schedule to form a medium strength zone or the hard strength zone may include heating the blank at 870 degrees Celsius or higher and at a rate to avoid coating vaporization. For example, coating vaporization occurs at 12 degrees Celsius per second for Usibor.

If an uncoated material is selected for the blank, the thermal treatment schedule to form a soft strength zone may include arranging the blank with a heating device so that the targeted soft zones of the blank receive minimal or no heat to retain a ferrite and/or pearlite microstructure.

If an uncoated material is selected for the blank, the thermal treatment schedule to form a medium strength zone may include heating the targeted medium strength zone at Ac1 to Ac3 to form a microstructure having one or more of ferrite, pearlite, bainite, and martensite. Ac3 is the transformation temperature at which ferrite fully transforms into austenite. Temperatures associated with Ac1 and Ac3 will vary depending on the type of uncoated material.

If an uncoated material is selected for the blank, the thermal treatment schedule to form a hard strength zone may include heating the targeted hard strength zone above Ac3 to fully austenitize the blank and form the fully martensitic microstructure.

In operation 112, the blank is arranged within a furnace so that heat zones of the furnace align with the targeted zones of the blank based on the identified thermal treatment schedule to heat each heat zone accordingly.

In operation 114, the blank is thermally treated according to the thermal treatment schedule including subjecting the blank to heat based on the type of material of the blank and desired microstructures of blank zones. For example, a portion of the coated blank in which a hard strength zone is desired is arranged with a furnace heat zone to receive heat at a temperature at or above 900 degrees Celsius. A portion of the blank in which a medium strength zone is desired may be arranged with a furnace heat zone to receive heat at a temperature between 700 and 900 degrees Celsius. A portion of the blank in which a soft strength zone is desired may be arranged with the furnace to receive minimal or no heat to retain a microstructure of the soft strength zone. In general, temperature and heat times are lower for an uncoated blank.

Optionally, the thermal treatment schedule may include a tailored cooling process or a uniform cooling process to assist in forming the desired microstructures. With tailored cooling, each of the different strength zones may be cooled at a different rate. Cooling at a rate above a critical cooling rate forms the hard strength zone. Cooling at a rate below the critical cooling rate forms the medium strength zone.

In operation 116, the blank is formed into a vehicle component within a die. As described further below, examples of vehicle components include an underbody assembly rear rail, an underbody assembly front rail, a bumper beam, and cross members of a vehicle component protection assembly. In operation 120 the vehicle component may be press-hardened by a cooling process within the die.

FIG. 2 is a schematic representation, in cross-section, of an example relationship between a blank and a heating apparatus for targeted thermal treatment as described in the method 100. A blank 140 includes a first portion 142, a second portion 144, a third portion 146, and a fourth portion 148. A predetermined microstructure for each of the portions of the blank 140 may be identified prior to operation of a heat apparatus 152. The heating apparatus 152, such as a furnace, includes a first heat zone 154, a second heat zone 156, and a third heat zone 158. The heating apparatus 152 may operate to heat each of the heat zones at a predetermined temperature to form the predetermined microstructure for the portion of the blank 140. For example, the first portion 142 located outside of the heating apparatus 152 may receive minimal or no heat to retain a ferrite and/or pearlite microstructure, the first heat zone 154 may be heated to a temperature to form a microstructure having one or more of ferrite, pearlite, martensite, and bainite of the second portion 144, the second heat zone 156 may be heated to a temperature to form a fully martensitic microstructure of the third portion 146, and the third heat zone 158 may be heated to a temperature to form a microstructure having one or more of ferrite, pearlite, martensite, and bainite of the fourth portion 148.

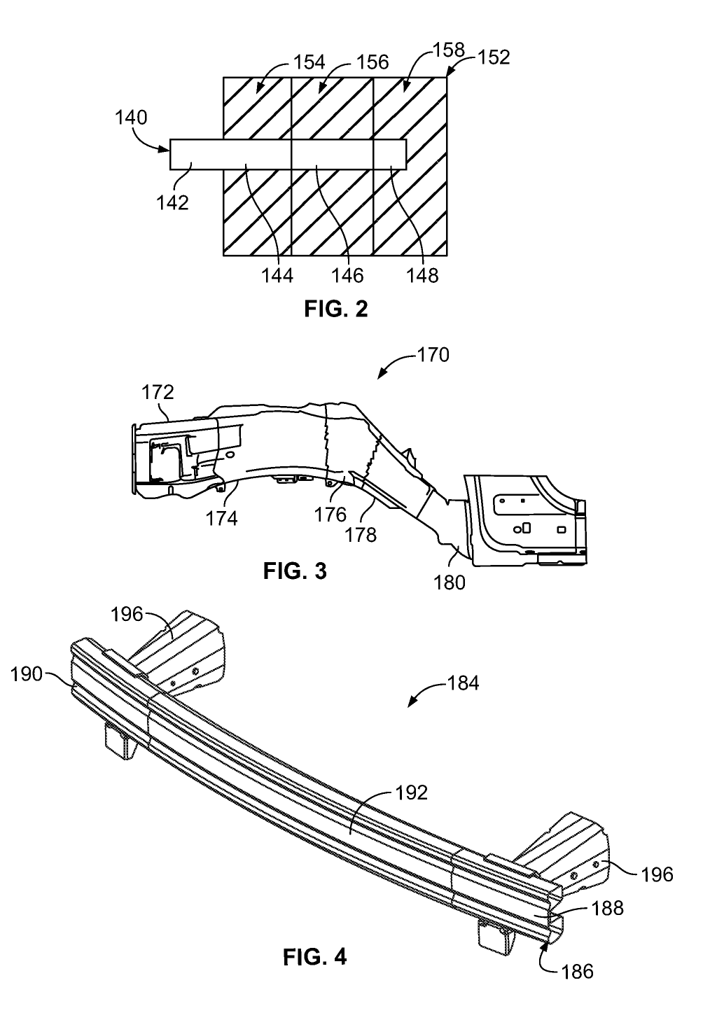

FIGS. 3 through 6 illustrate examples of vehicle components which may be created with the method 100 described above. FIG. 3 illustrates an example of a front rail 170 for a vehicle underbody assembly which may be thermally treated to accommodate for a design requirement relating to a geometry transition. The front rail 170 may be created by the method 100 to form various strength zones. For example, the front rail 170 may include a first zone 172, a second zone 174, a third zone 176, and a fourth zone 178. The third zone 176 extends between the second zone 174 and the fourth zone 178. The third zone 176 may be located at a portion of the front rail 170 including a bend at a transition between a front portion of the front rail 170 and an upper end of the backup structure 180.

FIG. 4 illustrates an example of a bumper assembly 184 for a vehicle which may be thermally treated to accommodate for a design requirement relating to targeted deformation characteristics. Components of the bumper assembly 184 may be created by the method 100 to form various strength zones. For example, the bumper assembly 184 includes a bumper beam 186 having a first end 188, a second end 190, and a middle portion 192 extending between the first end 188 and the second end 190. The first end 188 extends inboard and outboard of one of a pair of crush cans 196. The second end 190 extends inboard and outboard of the other of the crush cans 196.

Prior art examples of bumper beams may have a uniform martensitic structure which may prevent desired deformation when subjected to an impact. Selectively located and varied strength zones along the bumper beam 186 may assist in achieving desired deformation resulting from an impact. For example, the first end 188 and the second end 190 may be thermally treated to define medium strength zones having a tensile strength less than 1000 MPA. The middle portion 192 may be thermally treated to define a hard strength zone having a tensile strength between 1000 MPa and 1900 MPa. The zone identifiers may be defined by a microstructure made available on a vehicle component due to the thermal treatment as described above. Thermally treating the first end 188 and the second end 190 as medium strength zones will allow the bumper beam 186 to selectively deform when subjected to an impact and provide additional crush distance in front of the respective crush can 196 to absorb energy from an impact. If the bumper beam 186 is not thermally treated with different strength zones, the bumper beam 186 may not deform appropriately to dissipate energy when subjected to an impact. In a bumper beam example without different strength zones, the bumper beam may intrude into supporting crush cans resulting in higher forces and energy for the crush cans to absorb.

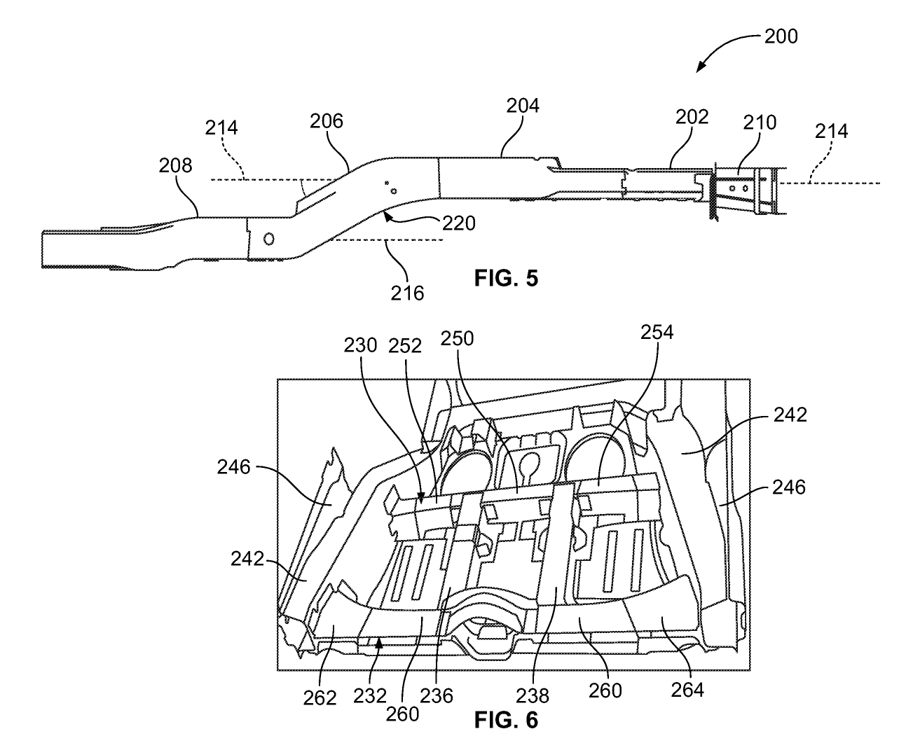

FIG. 5 illustrates an example of a rear rail 200 for a vehicle underbody assembly which may be thermally treated to accommodate a design requirement relating to a geometry transition. The rear rail 200 may be created by the method 100 to form various strength zones. The rear rail 200 includes a rear portion 202, a first mid-portion 204, a second mid-portion 206, and a forward portion 208. A crush can 210 extends from the rear portion 202. The rear portion 202 defines a first central axis 214. The forward portion 208 and part of the second mid-portion 206 define a second central axis 216. The first central axis 214 may be in a first plane and the second central axis 216 may be in a second plane. The second mid-portion 206 extends from the first central axis 214 to the second central axis 216 at a transition region 220. In one example, the second mid-portion 206 may extend downward and outboard to the forward portion 208.

The first mid-portion 204 may be thermally treated to form a medium strength zone and the second mid-portion 206 may be thermally treated to define a hard strength zone. Each of the rear rails 16 may be thermally treated so that the rear portion 202 and the forward portion 46 do not receive heat or receive minimal heat to retain a soft strength zone. The medium strength zone is formed to include a microstructure of one or more of ferrite, pearlite, martensite, and bainite and has a tensile strength of 600 MPa to 1000 MPa. The hard strength zone is formed to include a fully martensitic microstructure and has a tensile strength of 1000 MPa to 1900 MPa. The soft strength zone includes a microstructure of ferrite and/or pearlite and has a tensile strength of 400 MPa to 600 MPa. The first mid-portion 204 may be heated at between 700 and 900 degrees Celsius to form the medium strength zone. The second mid-portion 206 may be heated at or above 900 degrees Celsius to form the hard strength zone.

FIG. 6 illustrates an example of a protection assembly for a vehicle underbody in which components may be thermally treated to accommodate for a design requirement relating to targeted deformation characteristics. The protection assembly includes a first cross member 230, a second cross member 232, a first longitudinal member 236, a second longitudinal member 238, and a pair of side rails 242. Each of the first cross member 230 and the second cross member 232 extend between the pair of side rails 242. Each of the pair of side rails 242 is mounted to one of a pair of rockers 246. Each of the first longitudinal member 236 and the second longitudinal member 238 extend between the cross members. The protection assembly provides structural reinforcement when side and rear impacts are received. For example, a fuel tank may be arranged with the protection assembly to prevent or limit contact to the fuel tank by other vehicle components due to a vehicle impact. Targeted thermal treatment of the components of the protection assembly assists in preventing or limiting the contact.

For example, the first cross member 230 may be thermally treated to form a hard strength zone at a central region 250 and soft strength zones on either side of the central region 250 at a first end 252 and a second end 254. The second cross member 232 may be thermally treated to form a hard strength zone at a central region 260 and soft strength zones on either side of the central region 260 at a first end 262 and a second end 264.

Thermally treating the ends of the first cross member 230 and the second cross member 232 to form strength zones having a lower tensile strength than the respective central regions may create a lower strength material area for creating a “living hinge” or hinge joint to absorb energy and minimize deformation into a fuel tank region. The soft strength zones of the ends of the first cross member 230 and the second cross member 232 provide additional crash distance or deformation distance to minimize or prevent a side-impacted vehicle component from entering the fuel tank region. A location of soft strength zones at crush contact areas assists in facilitating sectional collapse of the first cross member 230 and the second cross member 232 to provide additional energy absorption before the impact load reaches the hard strength zone of the respective central region.

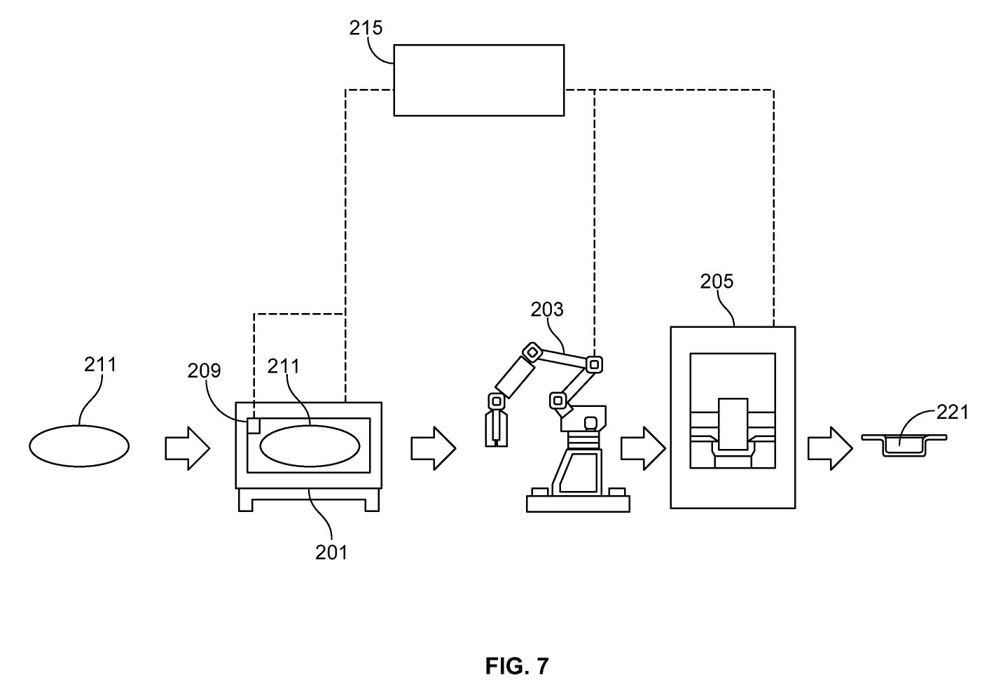

As mentioned above, the method 100 may operate with an adaptive system to control temperature output commands to a furnace. FIG. 7 is a diagrammatic view of an example of a hot-stamping line that may use an adaptive control system. The adaptive control system may include a furnace 201, a robotic transfer system 203, and a die 205. One or more sensors may be included within the adaptive system to monitor various conditions thereof. For example, a sensor 209 may be positioned upon the furnace 201 to identify characteristics and conditions of a blank 211 prior to entering the furnace. The sensor 209 may detect material properties of the blank 211 and whether any coating is present. Optionally, the furnace 201 may include a furnace sensor (not shown) to monitor thermal conditions within the furnace 201.

A controller 215 may be in communication with the furnace 201, the robotic transfer system 203, the die 205, and the one or more sensors to direct operation thereof. The controller 215 may be programmed for various operations such as the thermal treatment process described herein. For example, the controller 215 may be programmed to direct operation of the adaptive control system based on information received from the one or more sensors. A thermal treatment schedule and stamping schedule may be initiated upon detection by the sensor 209 of a particular type of material of the blank 211 and a vehicle component input. In another example, a temperature command may be sent to the furnace 201 from the furnace sensor based on measured thermal conditions of the furnace 201 as described above.

In one example of operation, the blank 211 may be positioned in the furnace 201 and heated above a phase transformation temperature forming austenite. The phase transformation temperature is the transformation temperature at which ferrite fully transforms into austenite. For example, the blank 211 may be heated at 900 to 950 degrees Celsius for a predetermined time in the furnace 201. The bake time and furnace temperature may vary depending on the material of the blank 211 and desired properties of the finished part. After heating, the robotic transfer system 203 may transfer the blank 211, now austenitized, to the die 205. The die 205 stamps the blank 211 into a desired shape of a vehicle component 221 while the blank 211 is still hot.

The vehicle component 221 may be cooled by a uniform or tailored cooling process as described above. For example, the vehicle component 221 may be quenched while the die 205 is still closed using water or other coolant. Quenching may be provided at a cooling speed of 30 to 150 degrees Celsius per second for a predetermined duration at the bottom of the stroke. After quenching, the vehicle component 221 is removed from the die 205 while the vehicle component 221 is still hot (e.g., about 150 degrees Celsius). The vehicle component 221 may then be cooled on racks.

While various embodiments are described above, it is not intended that these embodiments describe all possible forms encompassed by the claims. The words used in the specification are words of description rather than limitation, and it is understood that various changes can be made without departing from the spirit and scope of the disclosure. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A method for forming varied strength zones of a vehicle component comprising:
selecting a material for a blank and identifying a thermal treatment schedule for at least three blank zones based on a selected design requirement specifying a blank location for one of a geometry transition region, a predetermined deformation region, and a joining region;
arranging the blank within a furnace so that predetermined heat zones align with the blank zones to form predetermined microstructures based on the selected design requirement;
executing the thermal treatment schedule to form the predetermined microstructures of the blank zones; and
forming the blank into the vehicle component in a die.

2. The method of claim 1, wherein the selecting a material for the blank comprises selecting a press hardenable steel grade from one of 20MNB5, 22MNB5, 8MNCrB3, 27MnCrB5, 37MnB4, Aperam Hot Forming Grades, Ductibor, HF 340/480, Usibor 1500, HF1050/1500, Usibor 1900, HF 1200/1900, and US Steel 10B20.

3. The method of claim 1 further comprising detecting whether the blank includes a coating prior to execution of the thermal treatment schedule, wherein a first thermal treatment schedule is applied to the blank when a coating is detected and a second thermal treatment schedule is applied to the blank when a coating is not detected.

4. The method of claim 3, wherein the first thermal treatment schedule is further defined as a thermal treatment schedule in which furnace heat output is based on material characteristics of one of zinc, aluminum-silicon, and zinc nickel and predetermined temperatures necessary to form a blank microstructure including one of soft strength zone characteristics, medium strength zone characteristics, and hard strength zone characteristics.

5. The method of claim 1 further comprising arranging the blank within the furnace so that one of the at least three blank zones extends outside of the furnace to receive minimal or no heat.

6. The method of claim 1, wherein a temperature of one of the predetermined heat zones is 900 degrees Celsius or greater than an Ac3 temperature of the material to form a hard strength zone.

7. The method of claim 1, wherein a temperature of one of the predetermined heat zones is between Ac1 and Ac3 temperatures of the selected material of the blank to form a medium strength zone of the blank located adjacent a hard strength zone of the blank, and wherein the medium strength zone is defined in the selected design requirement to achieve strength levels in between the blank as received condition and a fully hardened condition of a press hardenable steel material.

8. A vehicle component strength zone forming method:
identifying a condition of a blank via sensors at a furnace inlet; and
outputting, by a controller, furnace command signals based on a predetermined thermal treatment schedule for the identified condition of the blank to heat a first blank portion to form a fully martensitic microstructure and heat a second blank portion to form a microstructure having one or more of ferrite, pearlite, and austenite.

9. The method of claim 8 further comprising outputting the furnace command signals based on furnace temperature variations detected by furnace sensors in communication with the controller.

10. The method of claim 8 further comprising outputting the furnace command signals based on one or more of a detected blank chemical composition, a detected type of blank coating, a detected blank thickness, and a detected blank material type.

11. The method of claim 8, wherein the furnace command signals are based on detection of the blank being one of Aperam Hot Forming Grades, Ductibor, HF 340/480, Usibor 1500, HF1050/1500, Usibor 1900, HF 1200/1900, and US Steel 10B20.

12. The method of claim 8 further comprising detecting whether the blank includes a coating prior to execution of the thermal treatment schedule, wherein a first thermal treatment schedule is applied to the blank when a coating is detected and a second thermal treatment schedule is applied to the blank when a coating is not detected.

13. The method of claim 12, wherein the first thermal treatment schedule is further defined as a thermal treatment schedule in which furnace heat output is based on material characteristics of one of zinc, aluminum-silicon, and zinc nickel and predetermined temperatures necessary to form a blank microstructure including one of soft strength zone characteristics, medium strength zone characteristics, and hard strength zone characteristics.

14. The method of claim 8 further comprising selecting a location for the first blank portion on a vehicle component based on a predetermined design requirement having one of a geometry transition region, a predetermined deformation region, and a joining region.

15. A method for forming varied strength zones of a vehicle component comprising:
selecting a type of material for a blank to form into a vehicle component based on a predetermined strength requirement and a corrosion protection requirement for the vehicle component;
selecting a thermal treatment schedule based on the type of material;
executing the thermal treatment schedule within a furnace to treat the blank to form varied strength zones along the vehicle component; and
executing a tailored cooling process for separate portions of the blank to form at least two different strength zone microstructures adjacent one another at one of a geometry transition region, a predetermined deformation region, and a joining region.

16. The method of claim 15, wherein the selection of the thermal treatment schedule is from one of a first schedule in which the blank is fully inserted into a furnace and a second schedule in which a portion of the blank extends outside the furnace.

17. The method of claim 15, wherein the furnace comprises more than one heat zone for heating at different temperatures, and wherein the blank is positioned in the furnace so that blank zones align with the more than one heat zones to form microstructures for the blank zones based on predetermined design requirements.

18. The method of claim 17, wherein a temperature of one of the heat zones is between Ac1 and Ac3 at approximately 700 to 900 degrees Celsius to form a medium strength zone of the blank located adjacent a hard strength zone of the blank, and wherein the medium strength zone is arranged to deform and absorb a portion of energy received from an axial load to the vehicle component of between 5,000 and 15,000 pounds.

19. The method of claim 15 further comprising detecting, via sensors, furnace thermal conditions and outputting a furnace command, via a controller, to adjust a temperature of the furnace based on the detected thermal condition.
